(19) United States
(12) Patent Application Publication
(10) Pub. No.: US 2024/0083053 A1
(43) Pub. Date: Mar. 14, 2024

(54) RAZOR CONNECTOR

(71) Applicant: BIC Violex Single Member S.A., Anoixi (GR)

(72) Inventors: Panagiotis KOPELAS, Anoixi (GR); Anestis TSEGENEDIS, Anoixi (GR); Argyro KALLIVRETAKI, Anoixi (GR); Polykarpos PSAROPOULOS, Anoixi (GR)

(73) Assignee: BIC Violex Single Member S.A., Anoixi (GR)

(21) Appl. No.: 18/465,704

(22) Filed: Sep. 12, 2023

(30) Foreign Application Priority Data
Sep. 12, 2022 (EP) 22195089.2
Sep. 12, 2022 (EP) 22195090.0

(51) Int. Cl. B26B 21/52; B26B 21/22; B26B 21/40

(52) U.S. Cl. CPC B26B 21/521; B26B 21/225; B26B 21/4062; B26B 21/528

(57) ABSTRACT

In a first aspect, the present disclosure relates to a razor connector configured to connect a razor cartridge to a razor handle. The razor connector includes at least one interlocking feature configured to interlock with at least one interlocking part of the razor cartridge and a push-button integrally formed with a hinge. The push-button is configured to rotate the hinge from a first to a second position upon actuation, wherein rotation of the hinge from the first to the second position is configured to disconnect the razor cartridge from the razor connector.

This application claims priority to the European Patent Application No. 22195089.2 filed on Sep. 12, 2022 and to the European Patent Application No. 22195090.0 filed on Sep. 12, 2022, the contents of which are incorporated herein in their entirety by this reference.

### TECHNICAL FIELD

The present disclosure relates to the field of razors. More specifically, the present disclosure relates to razor connectors which attach a razor cartridge to a razor handle.

### BACKGROUND

Razors are well known everyday items to shave of unwanted bodily hair, e.g. beard hairs. The razor may comprise a razor cartridge including blades configured to cut the hair and a razor handle used attached thereto. In use, a user holds the razor handle and brings the razor cartridge into contact with a portion of skin. By movement of the razor handle the razor cartridge moves in a shaving direction and unwanted hair is removed. The razor cartridge may be releasably connected to the razor handle via a razor connector. A releasable attachment of the razor cartridge may allow exchanging the razor cartridge, for example when the blades have become dull, instead of discarding the entire razor. However, razor connectors typically comprise complex mechanisms requiring multiple components, for example springs, pushers, push buttons, releasing mechanisms etc. The complex mechanisms increase the assembly complexity and increase the production time. Further, the multiple components, especially those that are movable, increase the risk of system failure as they are more prone to breaking.

The present disclosure aims to address the aforementioned issues in optimizing razor connectors.

### SUMMARY

In a first aspect, the present disclosure relates to a razor connector configured to connect a razor cartridge to a razor handle. The razor connector comprises at least one interlocking feature configured to interlock with at least one interlocking part of the razor cartridge and a push-button integrally formed with a hinge. The push-button is configured to rotate the hinge from a first to a second position upon actuation, wherein rotation of the hinge from the first to the second position is configured to disconnect the razor cartridge from the razor connector.

In embodiments, the razor connector comprises at least one interlocking feature configured to interlock with at least one interlocking part of the razor cartridge, a push-button integrally formed with a push-element, wherein the push-button is configured to move the push-element from a first position to a second position upon actuation, and wherein movement of the push-element from the first position to the second position is configured to disconnect the razor cartridge from the razor connector.

In embodiments, the razor connector may comprise a tongue, configured to allow pivotable movement of the razor cartridge relative to the razor handle.

In embodiments, the push-element may be arranged in distal direction of the push-button.

In embodiments, the first position may be disposed proximally of the second position.

In embodiments, the tongue may be a flexible tongue.

In embodiments, the hinge may be configured to be in contact with the razor cartridge, when the razor cartridge is connected to the razor connector.

In embodiments, the tongue may extend from a distal end of the razor connector and wherein the razor connector is configured to be connected to the razor handle at a proximal end and wherein the distal end and proximal end define a proximal-distal razor connector axis.

In embodiments, the hinge may be arranged in distal direction of the push-button.

In embodiments, the push-button may be connected to the hinge by a strut.

In embodiments, the hinge may be configured to rotate from the first position to the second position about an axis of rotation.

In embodiments, the hinge's axis of rotation may be substantially perpendicular to the proximal-distal razor connector axis.

In embodiments, the hinge's axis of rotation may be disposed further away from the proximal-distal razor connector axis compared to the push-button and/or the strut.

In embodiments, the at least one interlocking feature may be a recess, in particular a recess configured to interlock with at least one interlocking protrusion of the razor cartridge.

In embodiments, the at least one interlocking feature may be an interlocking protrusion, in particular an interlocking protrusion configured to interlock with at least one recess of the razor cartridge.

In embodiments, the protrusion may be configured to disconnect the razor cartridge from the razor connector upon actuation of the push-button by pushing the at least one interlocking part of the razor cartridge out of the at least one interlocking feature.

In embodiments, the hinge may be configured to disconnect the razor cartridge from the razor connector upon actuation of the push-button by pushing the at least one interlocking part of the razor cartridge out of the at least one interlocking feature.

In embodiments, the hinge may be configured to disconnect the razor cartridge from the razor connector upon actuation of the push-button by pushing the at least one interlocking part of the razor cartridge out of the at least one interlocking feature by at least a part of the hinge moving in the distal direction due to the rotation of the hinge around its axis of rotation.

In embodiments, the push-element may be configured to disconnect the razor cartridge from the razor connector upon actuation of the push-button by pushing the at least one interlocking part of the razor cartridge out of the at least one interlocking feature by at least a part of the push-element moving in the distal direction upon actuation of the push-button.

In embodiments, the push-element may be configured to disconnect the razor cartridge from the razor connector upon actuation of the push-button by pushing the at least one interlocking part of the razor cartridge out of the at least one interlocking feature by at least a part of the push-element moving in the distal direction and towards the proximal-distal razor connector axis upon actuation of the push-button.

In embodiments, the hinge may be configured to push the at least one interlocking part out of the at least one interlocking feature by moving the at least one interlocking part of the razor cartridge in distal direction relative to the at least one interlocking feature.

In embodiments, the hinge may be configured to push the at least one interlocking part out of the at least one interlocking feature by moving the at least one interlocking part of the razor cartridge in the distal direction and away from the proximal-distal razor connector axis relative to the at least one interlocking feature.

In embodiments, the hinge may comprise a protrusion, in particular wherein the protrusion is arranged on a distal end of the hinge, in particular wherein the protrusion is configured to be in contact with the razor cartridge, when the razor cartridge is connected to the razor connector.

In embodiments, the push-element may be configured to push the at least one interlocking part out of the at least one interlocking feature by moving the at least one interlocking part of the razor cartridge in distal direction relative to the at least one interlocking feature.

In embodiments, the push-element may be configured to push the at least one interlocking part out of the at least one interlocking feature by moving the at least one interlocking part of the razor cartridge in the distal direction and away from the proximal-distal razor connector axis relative to the at least one interlocking feature.

In embodiments, the push-button may move from a proximal position to a distal position upon actuation.

In embodiments, the push-button may be connected to an elastic structure configured to exert a biasing force on the push-button to return the push-button from the distal position to the proximal position, in particular wherein the push-button and the elastic structure are integrally formed.

In embodiments, a cross-section of the elastic structure, in particular along the proximal-distal razor connector axis, may be V-shaped, or curved, in particular at least partially a semi-circle.

In embodiments, the elastic structure may comprise one or more circular arcs, in particular wherein a top-view of the elastic structure is shaped as one or more circular arcs.

In embodiments, the protrusion may be configured to disconnect the razor cartridge from the razor connector upon actuation of the push-button by pushing the at least one interlocking part of the razor cartridge out of the at least one interlocking feature, more specifically wherein the protrusion may be configured to disconnect the razor cartridge from the razor connector upon actuation of the push-button by pushing the razor cartridge's protrusion of out of the razor connector's recess and in particular wherein the protrusion may be configured to disconnect the razor cartridge from the razor connector upon actuation of the push-button by pushing the razor cartridge's protrusion of out of the razor connector's recess by moving in the distal direction due to the rotation of the hinge around its axis of rotation.

In embodiments, the push-button may be preloaded when the razor cartridge is connected to the razor cartridge and/or, wherein the hinge may be preloaded when the razor cartridge is connected to the razor cartridge.

In embodiments, the push-element may be configured to be in contact with the razor cartridge, when the razor cartridge is connected to the razor connector.

In embodiments, the push-button may be preloaded when the razor cartridge is connected to the razor cartridge.

In embodiments, the protrusion may be configured to preload the razor cartridge when the razor cartridge is connected to the razor connector.

In embodiments, the push-button may be moved towards the proximal direction of the proximal-distal razor connector axis when preloaded.

In embodiments, the razor connector may comprise a receiving head configured to receive a connector sleeve of the razor cartridge.

In embodiments, the push-button may be arranged in proximal direction of the receiving head's distal end.

In embodiments, the push-button may comprise at least one actuation surface configured to be actuated by a user to release the razor cartridge, in particular by moving the actuation surface in distal direction of the proximal-distal razor connector axis.

In embodiments, the at least one actuation surface may be disposed substantially perpendicular to the proximal-distal razor connector axis.

In embodiments, the elastic structure may be arranged between the actuation surface and the hinge and/or the protrusion.

In embodiments, the at least one actuation surface may comprise an indicator, more specifically a haptic indicator and in particular a protrusion, a dot, a cavity, a groove and/or a rubber element.

In embodiments, the razor connector may have a top side and bottom side.

In embodiments, the tongue may comprise a first section extending parallel to the proximal-distal razor connector axis along the bottom side of the razor connector and a second section diverging towards the top side of the razor connector.

In embodiments, the push-button may be arranged on the top side or bottom side of the razor connector, in particular on the top side of the razor connector.

In embodiments, the tongue may have a polygonal cross-section, more specifically a square, rectangular or octagonal shape and in particular a rectangular shape.

In embodiments, a corner of the polygonal cross-section may be round.

In embodiments, the hinge may comprise a first and a second hinge, wherein the first and the second hinge may be disposed opposing one another, in particular wherein the proximal-distal razor connector axis is disposed between the first and the second hinge b.

In embodiments, the first hinge may comprise a first protrusion and the second hinge may comprise a second protrusion.

In embodiments, the first hinge may be connected to the push-button by a first strut and the second hinge may be connected to the push-button by a second strut.

In embodiments, the first hinge may be connected to a first push-button, in particular by a first strut, and the second hinge may be connected to a second push-button, in particular by a second strut.

In embodiments, the push-element may comprise a first push-element and a second push-element, wherein the first push-element and the second push-element may be disposed parallel to one another, in particular wherein the proximal-distal razor connector axis may be disposed between the first push-element and the second push-element.

In embodiments, the at least one interlocking feature may be positioned proximally of the receiving head's distal end, more specifically on the bottom side of the razor connector on the receiving head proximally of the receiving head's distal end and in particular on the bottom side of the razor connector on the receiving head proximally of the receiving head's distal end adjacent to the tongue.

In embodiments, the push-button may be integrally formed with the at least one interlocking feature.

In embodiments, the push-button may be integrally formed with the tongue.

In embodiments, the push-button, the at least one interlocking feature and the tongue may be integrally formed.

In embodiments, the razor connector may be a one-piece part.

In embodiments, the razor connector may comprise a plurality of layers, in particular a plurality of layers substantially parallel to each other.

In embodiments, the razor connector may be integrally formed with the razor handle.

In embodiments, a layer of the plurality of layers may have a thickness between about 5 μm to about 100 μm, more specifically between about 10 μm to about 50 μm and in particular between about 15 μm to about 30 μm.

In embodiments, a layer of the plurality of layers may have a thickness between about 0.05 mm to about 0.6 mm, more specifically between about 0.1 μm to about 0.4 mm and in particular between about 0.15 mm to about 0.3 mm.

In embodiments, the razor connector may comprise a first polymer, more specifically a photopolymer and in particular an ABS-like polymer and/or polypropylene-like polymer.

In embodiments, the first polymer may have a Shore D hardness between about 50 to about 120, more specifically between about 55 to about 100 and in particular between about 60 to about 90, measured according to ISO 868:2003.

In embodiments, the razor connector may comprise a second polymer.

In embodiments, the second polymer may have a shore A hardness between about 10 to about 95, more specifically between about 25 to about 80 and in particular between about 35 to about 60, measured according to ASTM D2400-15.

In embodiments, the razor connector may comprise a third polymer, more specifically a thermoplastic polymer and in particular ABS and/or polypropylene.

In embodiments, the razor connector may comprise a fourth polymer, more specifically a thermoplastic elastomer and in particular a TPA, a TPC, a TPO, a TPS, a TPV, a TPZ and/or a TPU.

In embodiments, the hinge may be connected to the receiving head at a connection shoulder, in particular wherein the connection shoulder comprises the second and/or fourth polymer.

In embodiments, the flexible tongue may comprise the second and/or fourth polymer.

In embodiments, the elastic structure may comprise the second and/or fourth polymer.

In embodiments, the push-button may comprise the first and/or third polymer.

In embodiments, the protrusion may comprise the first and/or third polymer.

In embodiments, the tongue may be connected to a spring, more specifically a spring configured to allow the tongue to move along the proximal-distal razor connector axis and in particular a spring that compresses and stretches along the proximal-distal razor connector axis.

In a second aspect of the present disclosure relates to a razor system comprising a razor connector of any preceding embodiment according to the first aspect and a razor cartridge, wherein the razor cartridge is releasably attached to the razor connector.

In embodiments according to the second aspect the razor system may further comprise a razor handle connected to the razor connector.

In a third aspect, the present disclosure relates to a method for manufacturing a razor connector according to any preceding embodiment according to the first aspect. The method comprises manufacturing the razor connector using a computer-controlled manufacturing system, in particular additive manufacturing, material jetting, fused filament fabrication, stereolithography and/or selective laser sintering.

In a fourth aspect the present disclosure relates to a computer-based manufacturing system for manufacturing a razor connector, comprising a control unit adapted to execute the method according to the third aspect.

In a fifth aspect the present disclosure relates to a computer program comprising computer readable code which cause a computer-based manufacturing system to carry out the method according to the third aspect.

In a sixth aspect the present disclosure relates to a computer readable medium comprising the computer readable code according to the fifth aspect.

In an eighth aspect the present disclosure relates to a model of the razor connector according to any embodiment according to the first aspect for a computer-controlled manufacturing system, wherein the model is configured to be processed by the computer-controlled manufacturing system to manufacture the razor connector.

In a ninth aspect, the present disclosure relates to a computer-readable medium, wherein the computer-readable medium comprises instructions configured to be processed by a computer-controlled manufacturing system to manufacture the razor connector according to any embodiment according to the first aspect.

### DESCRIPTION OF THE DRAWINGS

FIG. 1 shows a top view of a razor handle with a razor connector according to the present disclosure.

FIG. 2 shows an enlarged version of the razor connector of FIG. 1.

FIG. 3 shows a razor connector of FIG. 2 connected to a razor cartridge.

FIG. 4 shows a razor connector according to the present disclosure comprising two struts.

FIG. 5 shows a cross-section of a razor connector according to the present disclosure.

FIG. 6 shows an isometric bottom view of a razor connector according to the present disclosure.

FIG. 7 shows a breakout view of a razor connector according to the present disclosure depicted an elastic structure.

FIG. 8 shows a razor connector according to the present disclosure comprising a strut and a push-protrusion.

FIG. 9 shows a razor connector connected to a razor cartridge.

FIG. 10 shows a cross-section of a razor connector along the proximal-distal razor connector axis according to the present disclosure.

FIG. 11 shows a cross-section of an embodiment of a razor connector along the cutting plane line A-A according to the present disclosure.

FIG. 12 shows a breakout view of a razor connector according to the present disclosure depicted an elastic structure.

FIG. 13 shows an isometric bottom view of a razor connector according to the present disclosure.

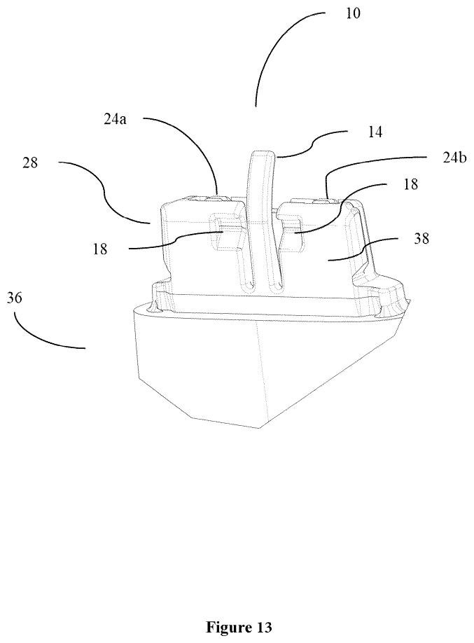

### DETAILED DESCRIPTION

Hereinafter, a detailed description will be given of the present disclosure. The terms or words used in the description and the aspects of the present disclosure are not to be construed limitedly as only having common-language or dictionary meanings and should, unless specifically defined otherwise in the following description, be interpreted as having their ordinary technical meaning as established in the relevant technical field. The detailed description will refer to specific embodiments to better illustrate the present disclosure, however, it should be understood that the presented disclosure is not limited to these specific embodiments.

Razor connectors typically comprise multiple components, in particular multiple movable components. The number of components increases the required assembly time during production, as well as the risk of breaking of the razor connector.

In a first aspect, the present disclosure relates to a razor connector 10 configured to connect a razor cartridge 100 to a razor handle 12. The razor connector 10 comprises at least one interlocking feature configured to interlock with at least one interlocking part of the razor cartridge 100 and a push-button 16 integrally formed with a hinge 24. The push-button 16 is configured to rotate the hinge 24 from a first to a second position upon actuation, wherein rotation of the hinge 24 from the first to the second position is configured to disconnect the razor cartridge 100 from the razor connector 10.

The razor connector 10 according to the first aspect may significantly reduce the required assembly time compared to other types of razor connectors.

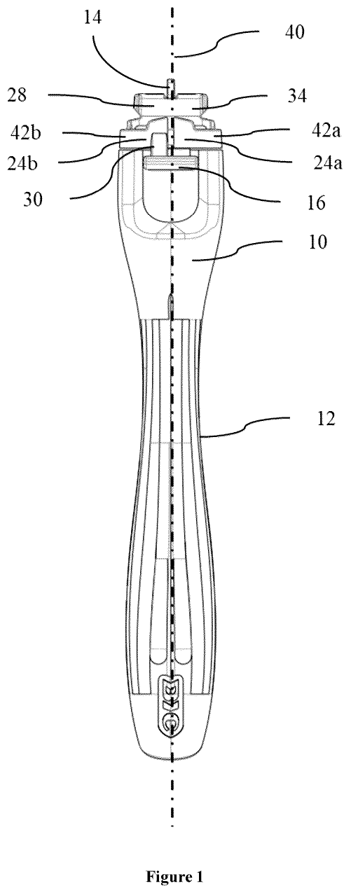

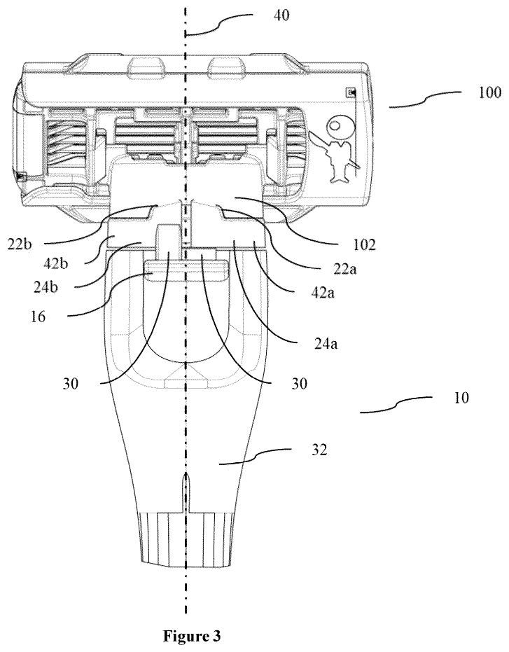

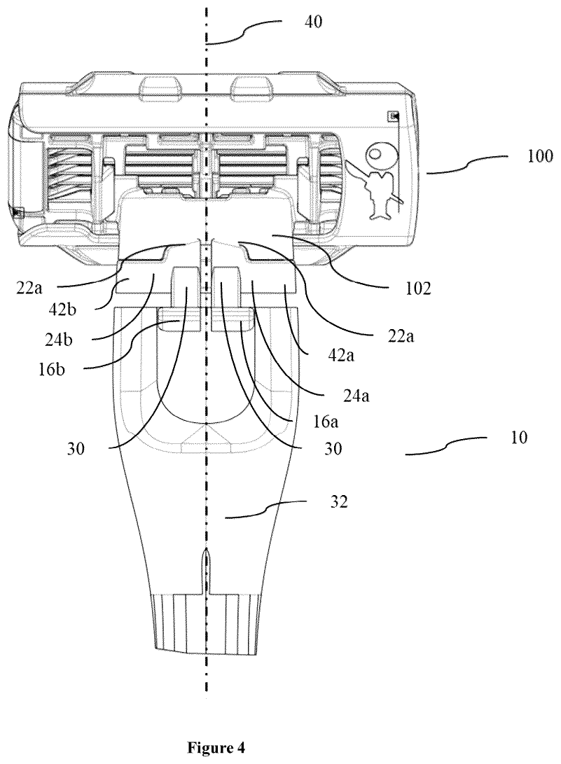

FIG. 1 illustrates a top view of an exemplary razor connector 10 according to the present disclosure with a razor handle 12. The razor connector 10 may be connected to the razor handle 12 at a proximal end and a razor cartridge 100 at the distal end, as shown in FIGS. 3 and 4. In embodiments, the razor connector 10 may comprise a tongue, configured to allow pivotable movement of the razor cartridge 100 relative to the razor handle 12. The tongue 14 may extend from a distal end of the razor connector 10. The distal end and proximal end may define the proximal-distal razor connector axis 40. FIG. 1 shows the proximal-distal razor connector axis 40 running centrically through the razor connector 10.

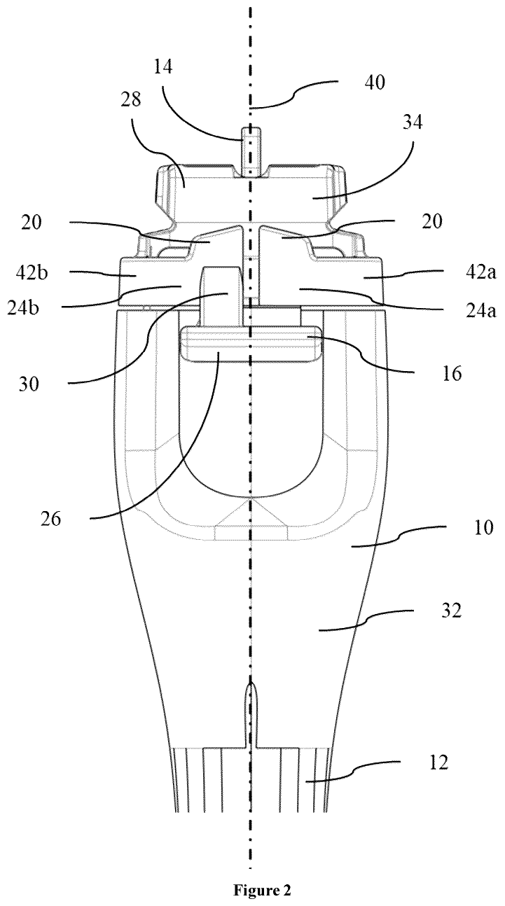

FIG. 2 is a more detailed top view of the exemplary razor connector 10. FIG. 2 shows two hinges 24a, 24b. In embodiments, the razor connector may comprise only one hinge.

As shown in FIG. 2 the hinge 24b is integrally formed with the push-button 16. The hinge 24 may be arranged towards the razor connector's 10 distal end. The hinge 24 may be arranged in distal direction of the push-button 16 and/or may be attached to the push-button 16 at the hinge's 24 proximal end. As is furthermore depicted in FIG. 2, the push-button 16 may be connected to the hinge 24b by a strut 30.

In embodiments, the hinge 24 may comprise a first 24a and a second hinge 24b, wherein the first 24a and the second hinge 24b may be disposed opposing one another, in particular wherein the proximal-distal razor connector axis 40 is disposed between the first 24a and the second hinge 24b. FIG. 4 depicts an embodiment wherein the first hinge 24a is connected to a first push-button 16a, in particular by a first strut 30a, and the second hinge 24b is connected to a second push-button 16b, in particular by a second strut 30b. Alternatively, the first hinge 24a may be connected to the push-button 16 by a first strut 30a and the second hinge 24b may be connected to the push-button 16 by a second strut 30b. A single push-button 16 may facilitate handling by the user. Two push-buttons 16a, 16b may require less force for actuation of the push-buttons 16a, 16b.

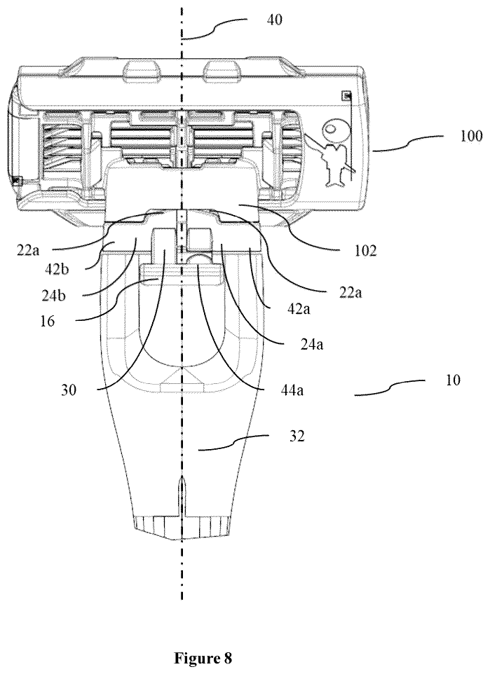

Alternatively or additionally, the razor the push-button 16 may not be directly connected to a hinge 24. As depicted in FIG. 8, the push-button 16 may comprise a push-protrusion 44a. The push-protrusion 44a may push against the proximal end of the hinge 24a, in particular a portion of the proximal end of the hinge 24a disposed towards the razor connector axis 40, when the push-button 16 is actuated, which may lead to the rotation of the hinge 24a. The strut 30 and push-protrusion 44a may be suitably combined.

In embodiments, the push-button 16 may move from a proximal position to a distal position upon actuation. As the push-button 16 is integrally formed with the hinge 24, the push-button 16 may transfer forces to the hinge 24. Hence, when the push-button 16 is moved from a proximal position to distal position, the push-button 16 may exert a force in distal direction upon the hinge 24.

In embodiments, the hinge 24 may be configured to rotate from the first position to the second position about an axis of rotation 42. The hinge's axis of rotation 42 may be substantially perpendicular or perpendicular to the proximal-distal razor connector axis 40. The hinge's axis of rotation 42 may be disposed further away from the proximal-distal razor connector axis 40 compared to the push-button 16 and/or the strut 30, as is indicated for example in FIG. 2. Hence, when the push-button 16 is moved in distal direction, a part of the hinge 24 may move at least partly in distal direction, in particular a part of the hinge 24 disposed closer to the proximal-distal razor connector axis 40 than the hinge's axis of rotation 42.

The hinge 24 may perform a hinge-type movement relative to the razor connector 10, in particular a hinge-type movement about the axis of rotation 42. The term “hinge-type movement” within this disclosure is well-known in the art and attributed its common meaning in this technical field. Additionally to the aforementioned definitions, the term “hinge-type movement” may refer to the hinge 24 performing a rotational movement relative to the razor connector around the axis of rotation 42.

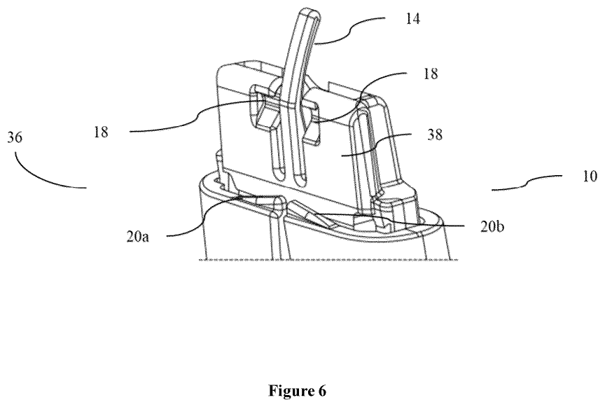

As mentioned above, the razor connector 10 according to the first aspect comprises at least one interlocking feature. As depicted in FIG. 6, the at least one interlocking feature may be a recess 18, in particular a recess 18 configured to interlock with at least one interlocking protrusion of the razor cartridge 100. Alternatively or additionally, the at least one interlocking feature may be an interlocking protrusion, in particular an interlocking protrusion configured to interlock with at least one recess of the razor cartridge 100

The interlocking protrusion and the recess may interlock through a snap-fit when the razor connector 10 is connected to a razor cartridge 100 on its distal end. The razor connector 10 or parts thereof and/or the razor connector or parts thereof may be flexible, improving the snap fit and allowing release of the snap-fit.

The hinge 24 may be configured to disconnect the razor cartridge 100 from the razor connector 10 upon actuation of the push-button 16 by pushing the at least one interlocking part of the razor cartridge 100 out of the at least one interlocking feature. More specifically, the hinge 24 may be configured to disconnect the razor cartridge 100 from the razor connector 10 upon actuation of the push-button 16 by pushing the at least one interlocking part of the razor cartridge 100 out of the at least one interlocking feature by at least a part of the hinge 24 moving in the distal direction due to the rotation of the hinge 24 around its axis of rotation 42.

As depicted in FIG. 3, the hinge 24 may be configured to be in contact with the razor cartridge 100, when the razor cartridge 100 is connected to the razor connector 10. The hinge 24 may be configured to push the at least one interlocking part out of the at least one interlocking feature by moving the at least one interlocking part of the razor cartridge 100 in distal direction relative to the at least one interlocking feature.

As depicted for example in FIG. 2 and FIG. 6, the hinge 24 may comprise a protrusion 20, in particular wherein the protrusion 20 is arranged on a distal end of the hinge 24, in particular wherein the protrusion 20 is configured to be in contact with the razor cartridge 100, when the razor cartridge 100 is connected to the razor connector 10. The protrusion 20 may improve the disconnection mechanism of the razor connector 10, in particular by exerting a force in distal direction on an adjacent part of the razor cartridge 100 when the hinge 24 is rotated about its axis of rotation 42. The protrusion 20 may act as a cam, hence the protrusion 20 may transform rotary motion to linear motion, in particular the protrusion 20 may transform hinge's 24 rotational movement about its axis of rotation 42 into a motion in the distal direction. In embodiments, the first hinge 24a may comprise a first protrusion 20a and the second hinge 24b may comprise a second protrusion 20b.

In embodiments, the protrusion 20 may be configured to disconnect the razor cartridge 100 from the razor connector 10 upon actuation of the push-button 16 by pushing the at least one interlocking part of the razor cartridge 100 out of the at least one interlocking feature, more specifically wherein the protrusion 20 may be configured to disconnect the razor cartridge 100 from the razor connector 10 upon actuation of the push-button 16 by pushing the razor cartridge's 100 protrusion of out of the razor connector's 10 recess 18 and in particular wherein the protrusion 20 may be configured to disconnect the razor cartridge 100 from the razor connector 10 upon actuation of the push-button 16 by pushing the razor cartridge's 100 interlocking protrusion of out of the razor connector's 10 recess 18 by moving in the distal direction due to the rotation of the hinge 24 around its axis of rotation 42.

Movement of the at least one interlocking part of the razor cartridge 100 in distal direction may release the snap fit. More specifically, as the hinge 24 and/or protrusion 20 may be in contact with the razor cartridge 100, movement of the at least part of the hinge 24 in distal direction may also move an adjacent part of the razor cartridge 100, e.g. a part of the razor cartridge comprising the at least one interlocking part, in distal direction leading to release of the snap fit.

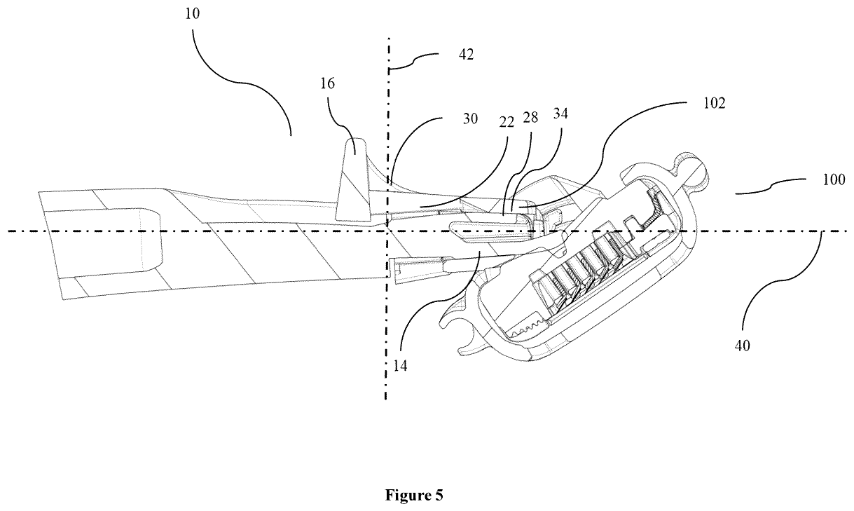

In embodiments, the hinge 24 and/or protrusion 20 may be configured to push the at least one interlocking part out of the at least one interlocking feature by moving the at least one interlocking part of the razor cartridge 100 in the distal direction and away from the proximal-distal razor connector axis 40 relative to the at least one interlocking feature. Movement of the at least one interlocking part of the razor cartridge 100 away from the proximal-distal razor connector axis 40 may undo the snap-fit and the movement into the distal direction may prevent reengagement as the at least one interlocking feature and at least one interlocking part may not be aligned anymore. Movement of the interlocking part of the razor cartridge 100 away from the proximal-distal razor connector axis 40 may for example be achieved by at least part of the hinge 24 or the protrusion 20 being configured to move between part of the razor cartridge 100 and the razor connector 10, e.g. parts of the razor cartridge 100 and the razor connector 10 in proximity of the at least one interlocking feature and at least one interlocking part. As shown in FIG. 5 the connector sleeve 102 may comprise an angular portion, which may facilitate movement by the protrusion 20 between the receiving head 28 and the razor connector sleeve 102. Further, in embodiments the protrusion 20 may comprise an angular portion at its distal end, which may facilitate movement by the protrusion 20 between the receiving head 28 and the razor connector sleeve 102.

Pushing the at least one interlocking part of the razor cartridge 100 out of the at least one interlocking feature of the razor connector 10 shall not be construed as requiring the hinge 24 or protrusion 20 to directly contact the at least one interlocking feature or part. The hinge 24 or protrusion 20 may merely push against another part of the razor cartridge 100, whereby the razor cartridge 100 moves in distal direction, which in turn may lead to the push out.

In embodiments, the razor connector comprises at least one interlocking feature configured to interlock with at least one interlocking part of the razor cartridge 100, a push-button 16 integrally formed with a push-element 24, wherein the push-button 16 is configured to move the push-element 24 from a first position to a second position upon actuation, and wherein movement of the push-element 24 from the first position to the second position is configured to disconnect the razor cartridge 100 from the razor connector 10.

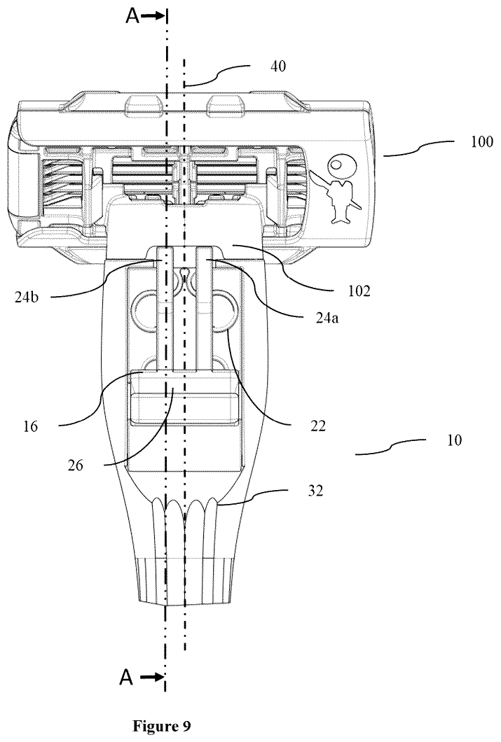

FIG. 9 is a more detailed top view of the exemplary razor connector 10 connected to a razor cartridge 100. FIG. 9 shows two push-elements 24a, 24b. In embodiments, the razor connector may comprise only one push-element. The push-element 24 may extend along the proximal-distal razor connector axis 40, in particular the push-element 24 may exhibit a greater extension along the proximal-distal razor connector axis 40 compared to the two directions perpendicular thereto. Additionally, the push-element 24 may be for example rod-shaped. Further, the push-element 24 may comprise one or more kinks or bends.

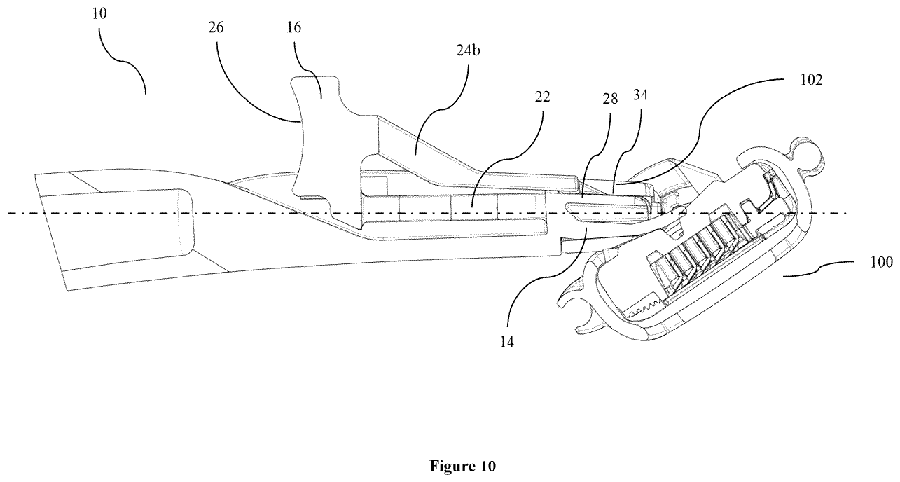

As shown in FIG. 9 and FIG. 10 the push-elements 24a, 24b are integrally formed with the push-button 16. The push element 24 may be arranged towards the razor connector's 10 distal end. The push-element 24 may be arranged in distal direction of the push-button 16 and/or may be attached to the push-button 16 at the push-element's 24 proximal end. As depicted in FIG. 10, the push-element 24 may comprise a first section diverging towards the proximal-distal razor connector axis 40 and a second section extending parallel to the proximal-distal razor connector axis 40, in particular wherein the second section is disposed in distal direction of the first section. The combination of the first section and second section may allow positioning push-button and actuation surface 26 further away from the proximal-distal razor connector axis 40 and/or other components of the razor connector 10, which may allow easier access to the actuation surface 26 and push-button 16 by the user.

In embodiments, the push-element may comprise a first 24a and a second push-element 24b, wherein the first 24a and the second push-element 24b may be disposed opposing one another, in particular wherein the proximal-distal razor connector axis 40 is disposed between the first 24a and the second push-element 24b.

In embodiments, the push-button 16 may move from a proximal position to a distal position upon actuation. As the push-button 16 is integrally formed with the push-element 24, the push-button 16 may transfer forces to the push-element 24. Hence, when the push-button 16 is moved from a proximal position to distal position, the push-button 16 may also move the push-element 24 in distal direction. Therefore, the push-element's first position may be disposed proximally of the second position.

As mentioned above, the razor connector 10 according to the first aspect comprises at least one interlocking feature. As depicted in FIG. 6, the at least one interlocking feature may be a recess 18, in particular a recess 18 configured to interlock with at least one interlocking protrusion of the razor cartridge 100. Alternatively or additionally, the at least one interlocking feature may be an interlocking protrusion, in particular an interlocking protrusion configured to interlock with at least one recess of the razor cartridge 100.

The interlocking protrusion and the recess may interlock through a snap-fit when the razor connector 10 is connected to a razor cartridge 100 on its distal end. The razor connector 10 or parts thereof and/or the razor connector or parts thereof may be flexible, improving the snap fit and allowing release of the snap-fit.

The push-element 24 may be configured to disconnect the razor cartridge 100 from the razor connector 10 upon actuation of the push-button 16 by pushing the at least one interlocking part of the razor cartridge 100 out of the at least one interlocking feature. More specifically, the push-element 24 may be configured to disconnect the razor cartridge 100 from the razor connector 10 upon actuation of the push-button 16 by pushing the at least one interlocking part of the razor cartridge 100 out of the at least one interlocking feature by at least a part of the push-element 24 moving in the distal direction upon actuation of the push-button 16.

As depicted in FIG. 9, the push-element 24 may be configured to be in contact with the razor cartridge 100, when the razor cartridge 100 may be connected to the razor connector 10. The push-element 24 may be configured to push the at least one interlocking part out of the at least one interlocking feature by moving the at least one interlocking part of the razor cartridge 100 in distal direction relative to the at least one interlocking feature.

Movement of the at least one interlocking part of the razor cartridge 100 in distal direction may release the snap fit. More specifically, as the push-element 24 may be in contact with the razor cartridge 100, movement of the push-element 24 in distal direction may also move an adjacent part of the razor cartridge 100, e.g. a part of the razor cartridge comprising the at least one interlocking part, in distal direction leading to release of the snap fit.

In embodiments, the push-element 24 may be configured to push the at least one interlocking part out of the at least one interlocking feature by moving the at least one interlocking part of the razor cartridge 100 in the distal direction and away from the proximal-distal razor connector axis 40 relative to the at least one interlocking feature. Movement of the at least one interlocking part of the razor cartridge 100 away from the proximal-distal razor connector axis 40 may undo the snap-fit and the movement into the distal direction may prevent reengagement as the at least one interlocking feature and at least one interlocking parts may not be aligned anymore. Movement of the at least one interlocking part of the razor cartridge 100 away from the proximal-distal razor connector axis 40 may for example be achieved by at least part of the push-element 24 being configured to move between part of the razor cartridge 100 and the razor connector 10, e.g. parts of the razor cartridge 100 and the razor connector 10 in proximity of the at least one interlocking feature and at least one interlocking part.

Pushing the at least one interlocking part of the razor cartridge 100 out of the at least one interlocking feature of the razor connector 10 shall not be construed as requiring the push-element 24 to directly contact the at least one interlocking feature or part. The push-element 24 may merely push against another part of the razor cartridge 100, whereby the razor cartridge 100 moves in distal direction, which in turn may lead to the push out.

In embodiments, the push-button 16 may be connected to an elastic structure 22 configured to exert a biasing force on the push-button 16 to return the push-button from the distal position to the proximal position, in particular wherein the push-button and the elastic structure 22 are integrally formed.

In embodiments, a cross-section of the elastic structure 22, in particular along the proximal-distal razor connector axis 40, may be V-shaped, or curved, in particular at least partially a semi-circle. The shape of the elastic structure 22, which is partially defined by its cross-section, may be chosen based on the desired movement of the push-button 16 upon actuation, as well as the desired movement of the hinge 24 upon actuation. For example, if the hinge 24 or protrusion 20 are configured to push the at least one interlocking part out of the at least one interlocking feature by moving the at least one interlocking part of the razor cartridge 100 in the distal direction and away from the proximal-distal razor connector axis 40 relative to the at least one interlocking feature, the shape of the elastic structure 22 may be chosen such that at least a part of hinge 24 or protrusion 20 move between part of the razor cartridge 100 and the razor connector 10 upon actuation of the push-button 16. For example, a curved elastic structure 22 may allow the push-button 16 to move towards the proximal-distal razor connector axis 40 which may move part of the hinge 24 or protrusion 20 also towards the proximal-distal razor connector axis 40, such that the part of the hinge 24 or protrusion 20 move between part of the razor cartridge 100 and the razor connector 10.

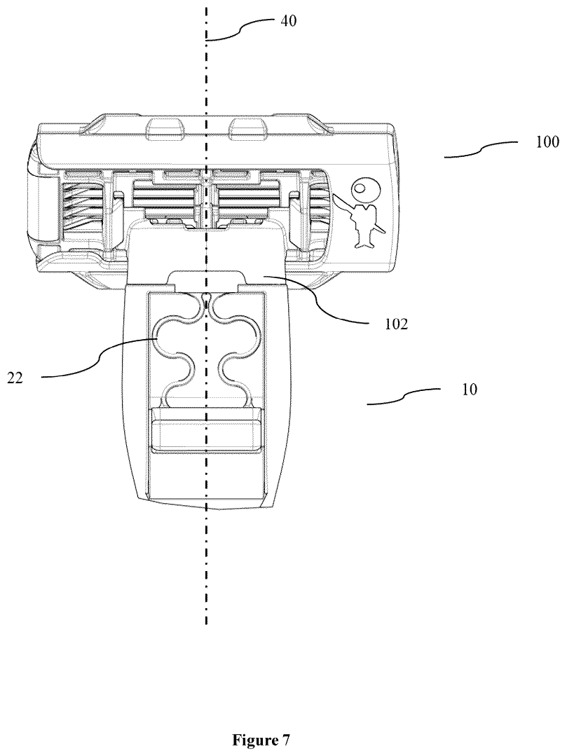

FIG. 7 is a breakout view of the razor connector 10 showing an embodiment of the elastic structure 22 in a top view. A plurality of details, such as the hinge 24, have been omitted in FIG. 7. As depicted in FIG. 7, the elastic structure 22 may comprise one or more circular arcs, in particular wherein a top-view of the elastic structure 22 is shaped as one or more circular arcs. The circular arcs may provide a high degree of elastic force to the elastic structure 22, even when integrally formed with the push-button 16.

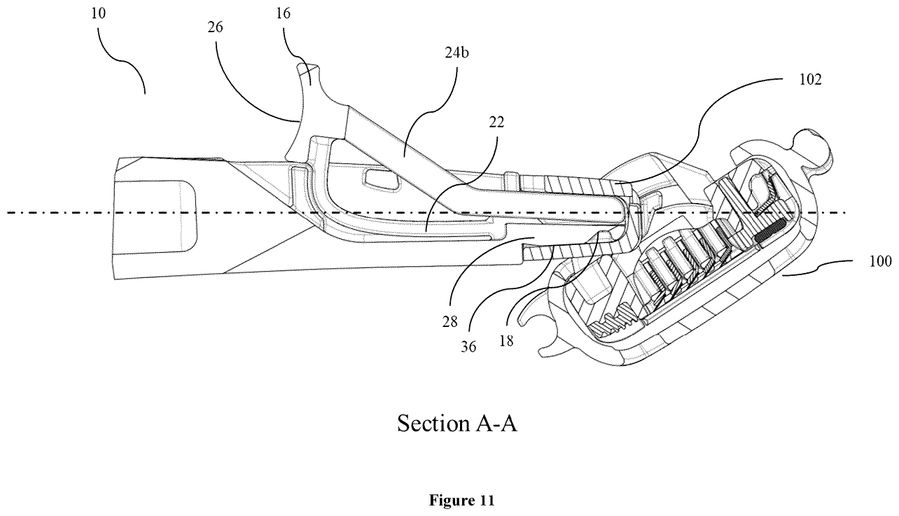

In embodiments, a cross-section of the elastic structure 22, in particular along the proximal-distal razor connector axis 40, may be V-shaped, or curved, in particular at least partially a semi-circle. FIG. 11 shows a curved elastic structure 22. The shape of the elastic structure 22, which is partially defined by its cross-section, may be chosen based on the desired movement of the push-button 16 upon actuation, as well as the desired movement of the push-element 24 upon actuation. For example, if the push-element 24 are configured to push the at least one interlocking part out of the at least one interlocking feature by moving the at least one interlocking part of the razor cartridge 100 in the distal direction and away from the proximal-distal razor connector axis 40 relative to the at least one interlocking feature, the shape of the elastic structure 22 may be chosen such that at least a part of the push-element 24 moves between part of the razor cartridge 100 and the razor connector 10 upon actuation of the push-button 16. For example, a curved elastic structure 22 may allow the push-button 16 to move towards the proximal-distal razor connector axis 40 which may move part of the push-element 24 also towards the proximal-distal razor connector axis 40, such that the part of the push-element 24 moves between part of the razor cartridge 100 and the razor connector 10.

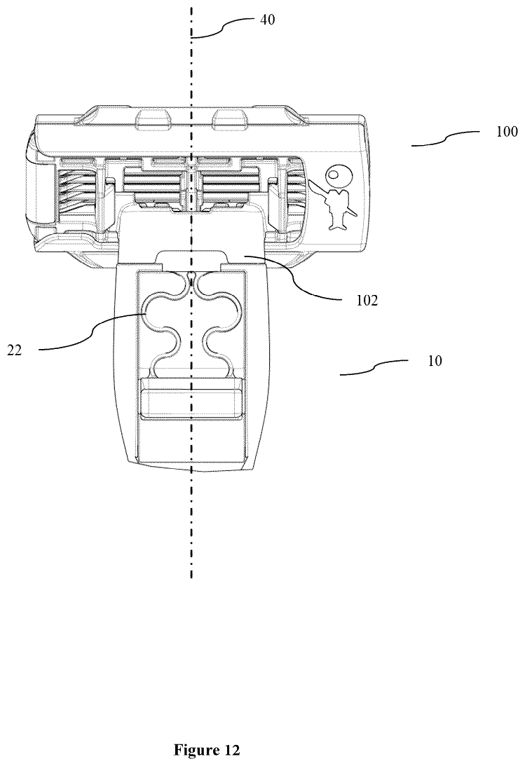

FIG. 12 is a breakout view of the razor connector 10 showing an embodiment of the elastic structure 22 in a top view. A plurality of details, such as the push-element 24, have been omitted in FIG. 12. As depicted in FIG. 12, the elastic structure 22 may comprise one or more circular arcs, in particular wherein a top-view of the elastic structure 22 is shaped as one or more circular arcs. The circular arcs may provide a high degree of elastic force to the elastic structure 22, even when integrally formed with the push-button 16.

In embodiments, the push-button 16 may be preloaded when the razor cartridge 100 is connected to the razor connector 10; and/or, wherein the hinge 24 may be preloaded when the razor cartridge 100 is connected to the razor connector 10. In embodiments, the push-button 16 may be moved towards the proximal direction of the proximal-distal razor connector axis 40 when preloaded. In embodiments, the push-button 16 may be preloaded when the razor cartridge 100 is connected to the razor connector 10. In embodiments, the push-button 16 may be moved towards the proximal direction of the proximal-distal razor connector axis 40 when preloaded. Preloading the push-button 16 or hinge 24 when connecting the razor cartridge 100 may reduce the required force for actuating the push-button to disconnect the razor cartridge, as at least part of the force is already provided due to the preloading.

In embodiments, the protrusion 20 or hinge 24 may be configured to preload the razor cartridge 100 when the razor cartridge 100 is connected to the razor connector 10.

In embodiments, the push-element 24 may be configured to preload the razor cartridge 100 when the razor cartridge 100 is connected to the razor connector 10.

Preloading the razor cartridge 100 may bias the razor cartridge 100 towards an angle relative to the razor handle 12, which may improve the handling of the razor for the user.

As mentioned above, the razor connector 10 may comprise a tongue 14, configured to allow pivotable movement of the razor cartridge 100 relative to the razor handle 12. The tongue 14 may connect and/or slide into a corresponding feature of the razor cartridge 100. The tongue 14 may restrict movement of the razor cartridge 100 relative to the razor connector 10 in certain axis. The tongue 14 may restrict movement of the razor cartridge 100 relative to the razor connector 10 orthogonally to the proximal-distal razor connector axis 40 and/or pivotable movement around the proximal-distal razor connector axis 40. This may improve the connection between the razor connector 10 and the razor cartridge 100, in particular it may prevent accidental release of the razor cartridge 100. The tongue 14 may however allow pivotable movement around an axis disposed orthogonally to the proximal-distal razor connector axis 40. This may in use allow the razor cartridge 100 to align to the surface of a user's skin. The tongue 14 may allow the razor cartridge 100 to align to the user's skin by a pivotable movement but may also apply a restoring force on the razor cartridge 100 to return to its original orientation relative to the razor handle.

In embodiments, the tongue 14 may be a flexible tongue 14. The term “flexible tongue” within this disclosure may refer to an elongated structure, in particular a structure elongated at least partly along the proximal-distal razor connector axis 40, wherein the elongated structure comprises or consists of an elastic material. The term “flexible tongue” may refer to an elongated structure allowing pivotable movement of a connected part, in particular a razor cartridge” due to elastic deformation. Additionally or alternatively, the term “flexible tongue” may refer to a flexible elongated structure not comprising movable parts, such as springs or slidable parts.

The flexible tongue 14 may further reduce the assembly time of the razor connector 10 compared to other components allowing pivotable movement of the razor cartridge 100. Further, the flexible tongue 14 may be integrally formed with other parts of the razor connector 10. The term “elastic material” within this disclosure may refer to a material which undergoes deformation when exposed to a force and returns, at least partly, to its original size and shape after the force is removed. Additionally or alternatively, the term “elastic material” within this disclosure may refer to a material which has an elongation at yield of at least 1%, more specifically at least 1.5% and in particular at least 2%, measured according to ISO 527-1:2019.

In embodiments, the razor connector 10 may comprise a receiving head 28 configured to receive a connector sleeve 102 of the razor cartridge 100. The receiving head 28 may align the tongue during its insertion into the razor cartridge 100. Further, the receiving head 28 may aid in preventing movement of the razor cartridge 100 orthogonally to the proximal-distal axis razor connector proximal-distal razor connector axis 40. The razor connector 10 may also connect to the razor connector 100 in other ways, in particular through other types of plug and socket connection types. Additionally, movement of the at least one interlocking part of the razor cartridge 100 away from the proximal-distal razor connector axis 40 may for example be achieved by at least part of the hinge 24 or the protrusion 20 being configured to move between the receiving head 28 and the connector sleeve 102 upon actuation of the push-button 16. As shown for example in FIG. 10 the connector sleeve 102 may comprise an angular portion, which may facilitate movement by the push-element 24 between the receiving head 28 and the razor connector sleeve 102. Further, in embodiments the push-element 24 may comprise an angular portion at its distal end, which may facilitate movement by the push-element 24 between the receiving head 28 and the razor connector sleeve 102.

As shown in FIG. 11, the push-element 24 may also protrude into the razor connector sleeve 102. In particular the push-element 24 may be in contact with a distal end of the razor connector sleeve 102. When the push-button 16 is actuated the push-element 24 may move towards the distal direction, while the receiving head 28 comprises the at least one interlocking feature, in particular the recess 18, stays in place. The push-element 24 may then push against the distal end of the razor connector sleeve 102 moving it in the distal direction, which may lead to the at least one interlocking part being moved out of the at least one interlocking feature, leading to the disconnection of the razor cartridge 100.

In embodiments, the push-button 16 may be arranged in proximal direction of the receiving head's 28 distal end. Arranging the push-button 16 proximally of the receiving head's 28 distal end may prevent unintentional interaction of the push-button 16 with the razor cartridge 100 and provide improved handling for the user.

In embodiments, the push-button 16 may comprise at least one actuation surface 26 configured to be actuated by a user to release the razor cartridge 100, in particular by moving the actuation surface 26 in distal direction of the proximal-distal razor connector axis 40.

In embodiments, the at least one actuation surface 26 may be disposed substantially perpendicular or perpendicular to the proximal-distal razor connector axis 40. Arranging the at least one actuation surface 26 substantially perpendicular or perpendicular to the proximal-distal razor connector axis 40 may allow ergonomic actuation by the user, in particular with his thumb.

In embodiments, the elastic structure 22 may be arranged between the actuation surface 26 and the hinge 24 and/or the protrusion 20.

In embodiments, the at least one actuation surface 26 may comprise an indicator, more specifically a haptic indicator and in particular a protrusion, a dot, a cavity, a groove and/or a rubber element. The haptic indicator may facilitate the identification of the actuation surface 26 by the user, in particular without looking at the razor connector 10 and only through haptic perception.

In embodiments, the razor connector 10 may have a top side 32 and bottom side 36 (shown for example in FIG. 2 and FIG. 6). The top side 32 may be the side facing against a shaving direction and the bottom side 36 the side facing towards the shaving direction. Alternatively or additionally, the top 32 and bottom 36 side may be defined relative to other components. Alternatively or additionally, the bottom side may be the razor connector's 10 side comprising the tongue, in particular the flexible tongue 14. Alternatively or additionally, the bottom side may be the razor connector's 10 side comprising the at least one interlocking feature. Additionally, the top side 32 may be the side opposite of the bottom side 36.

As depicted in FIGS. 5,6 and 10 in embodiments, the tongue 14 may comprise a first section extending parallel to the proximal-distal razor connector axis 40 along the bottom side 36 of the razor connector 10 and a second section diverging towards the top side 32 of the razor connector 10. This configuration may, in instances, be selected to allow the razor cartridge 100 to pivot relative to an axis disposed orthogonally to the proximal-distal razor connector axis 40, while preventing movement orthogonally to the proximal-distal razor connector axis 40.

In embodiments, the receiving head 28 may comprise a top side 34 (shown for example in FIG. 2) and a bottom side 38 (shown in FIG. 6). The top 34 and bottom side 38 of the receiving head 28 may be defined accordingly to the top 32 and bottom side 36 of the razor connector 10. As shown in FIGS. 6 and 11 the flexible tongue 14 may be connected to the receiving head 28, more specifically to the receiving head's 28 proximal end and in particular the receiving head's 28 bottom side's 38 proximal end. This configuration may increase the length of the tongue, which may allow for a greater deflection at the same force compared to a shorter tongue, which may improve the alignment of the razor cartridge 100 to the user's skin during the shaving action.

In embodiments, the push-button 16 may be arranged on the top side 32 or bottom side 36 of the razor connector 10, in particular on the top side 32 of the razor connector 10.

In embodiments, the tongue 14 may have a polygonal cross-section, more specifically a square, rectangular or octagonal shape and in particular a rectangular shape. In embodiments, a corner of the polygonal cross-section may be round. The rounded edges may facilitate sliding the tongue into the razor cartridge's 100 corresponding feature.

In embodiments, the push-element 24 may be positioned at the top side 32 of the razor connector 10. In embodiments, the push-element 24 may be positioned at the bottom side 36 of the razor connector 10.

In embodiments, the protrusion 20 may be placed at the top side 32 of the razor connector 10, in particular on the hinge's 24 distal section at the top side 32. In embodiments, the protrusion 20 may be placed at the bottom side 36 of the razor connector 10, in particular on the hinge's distal section at the bottom side 36. As shown for example in FIG. 2 and FIG. 6, the hinge 24 may comprise the protrusion 20 on its distal section at both the top side 32 and bottom side 36. This configuration may improve the release of the razor cartridge 100. A protrusion 20 placed only at the top side 32 or bottom side 36 may only tilt the razor cartridge 100 when the push-button 16 is actuated. A protrusion at both the top side during the actuation of the push-button 16 may push the razor cartridge 100 straight towards the razor connector's 10 distal end, which may release the razor cartridge 100. However, it may also be sufficient to place the protrusion 20 at only either the top side 32 or the bottom side 36. In particular, if the protrusion 20 is placed on the side comprising the at least one interlocking feature, in particular the recess 18, the protrusion 20 may push the razor cartridge 100 so far towards the distal end on that side, that the razor cartridge 100 is released from the razor connector 10, although the overall razor cartridge 100 only tilts relative to the razor connector 10.

In embodiments, the at least one interlocking feature may be positioned proximally of the receiving head's 28 distal end, more specifically on the bottom side 36 of the razor connector 10 on the receiving head 28 proximally of the receiving head's 28 distal end and in particular on the bottom side 36 of the razor connector 10 on the receiving head 28 proximally of the receiving head's 28 distal end adjacent to the tongue. Placing the at least one interlocking feature, in particular a recess 18 on the bottom side 38 of the razor connector 10 may be used e.g. if the bottom side 38 of the razor connector 10 is facing against the shaving direction, in some instances, as during the shaving action the at least one interlocking feature may be pressed together, due to the forces transferred to the razor cartridge 100 during the shaving action.

In embodiments, different parts of the razor connector 10 may be integrally formed with other parts of the razor connector 10. This may decrease the assembly time of the razor connector 10.

In embodiments, the push-button 16 may be integrally formed with the at least one interlocking feature. Additionally or alternatively, the push-button 16 may be integrally formed with the tongue. In embodiments, the push-button 16, the at least one interlocking feature and the tongue 14 may be integrally formed.

In embodiments, the razor connector 10 may be a one-piece part. Integrally forming parts of the razor connector 10 may decrease the assembly time of the razor connector 10 drastically. In particular, manufacturing the razor connector 10 as a one-piece part may lead to no assembly time for the razor connector 10 at all. FIGS. 1 to 7 show the razor connector 10 as a one-piece part.

To manufacture the razor connector 10 as a one-piece part different manufacturing technologies may be used. The razor connector 10 may be, in some instances, manufacturable by additive manufacturing technologies. The razor connector 10 may have a complex geometry, which may be efficiently manufacturable by additive manufacturing. In particular, the razor connector 10 may comprise multiple undercuts, which may make for example injection molding inefficient, especially if the razor connector 10 is intended to be manufactured as a one-piece part.

The razor connector 10 may be an individual part and connected to the razor handle 12 by a detachable or non-detachable connection, for example a push-in connection. Manufacturing the razor connector 10 as an individual part may be advantageous if the razor handle 12 can be rapidly and efficiently manufactured, e.g. by injection molding, whereas the razor connector 10 can only be manufactured with more cost and time intensive processes, e.g. additive manufacturing. In that case, an individually manufactured razor handle 12 and razor connector 10 may reduce the manufacturing time and cost of the complete razor. Further, a releasably attached individually formed razor connector 10 could be exchanged if it is worn out, while retaining the razor handle 12.

In examples, the razor connector 10 may be integrally formed with the razor handle 12. Integrally forming the razor connector 10 with razor handle 12 reduces the assembly time further.

In embodiments, the razor connector 10 may comprise a plurality of layers, in particular a plurality of layers substantially parallel to each other. The layered structure may comprise a plurality of layers, in particular a plurality of layers substantially parallel to each other. Additive manufacturing technologies, such as fused filament fabrication or material jetting may lead to a plurality of layers, in particular a plurality of layers substantially parallel to each other.

In embodiments, a layer of the plurality of layers may have a thickness between about 5 μm to about 100 μm, more specifically between about 10 μm to about 50 μm and in particular between about 15 μm to about 30 μm.

In embodiments, a layer of the plurality of layers may have a thickness between about 0.05 mm to about 0.6 mm, more specifically between about 0.1 μm to about 0.4 mm and in particular between about 0.15 mm to about 0.3 mm.

The thickness of the plurality of layers may depend upon the process used for manufacturing. Further, a smaller layer thickness may lead to an increased manufacturing time of the razor connector 10, but may also increase the mechanical stability and dimensional accuracy of the razor connector 10.

In embodiments, the razor connector 10 may comprise a first polymer, more specifically a photopolymer and in particular an ABS-like polymer and/or polypropylene-like polymer. A photopolymer and in particular an ABS-like polymer and/or polypropylene-like polymer may be processable by an additive manufacturing process such as stereolithography. The first polymer may have a Shore D hardness between about 50 to about 120, more specifically between about 55 to about 100 and in particular between about 60 to about 90, measured according to ISO 868:2003. The first polymer may be for example Durus or Rigur, by the company Stratasys, Ltd.

In embodiments, the razor connector 10 may comprise a second polymer. The second polymer may have a shore A hardness between about 10 to about 95, more specifically between about 25 to about 80 and in particular between about 35 to about 60, measured according to ASTM D2400-15. The second polymer may be for example Tango or Agilus 30, by the company Stratasys, Ltd.

In embodiments, the razor connector 10 may comprise a third polymer, more specifically a thermoplastic polymer and in particular ABS and/or polypropylene.

In embodiments, the razor connector 10 may comprise a fourth polymer, more specifically a thermoplastic elastomer and in particular a TPA, a TPC, a TPO, a TPS, a TPV, a TPZ and/or a TPU.

Thermoplastic elastomers, as well as ABS and/or polypropylene may be processable by technologies wherein a solid material is liquified and subsequently resolidified for manufacturing, for example extrusion. Thermoplastic elastomers, as well as ABS and/or polypropylene may in particular be processable by additive manufacturing technologies such as fused filament fabrication and/or selective laser melting.

Additive manufacturing technologies may also be employed as multi-material processes, wherein a one-piece part comprising at least two different materials can be manufactured. For example, stereolithography and fused filament fabrication may be used to create multi-material parts. In fused filament fabrication the manufacturing device, e.g. the 3D-printer, may comprise multiple nozzles, wherein each nozzle is configured to extrude a different polymer. In stereolithography the part to be produced may change between vats comprising different precursors. Hence, additive manufacturing may be employed to optimize properties of certain parts and/or regions of the razor connector 10 by varying the choice of material locally.

The second and/or fourth polymer may have a lower modulus of elasticity compared to the first and/or third polymer. A material with a lower modulus of elasticity exhibits a higher degree of deformation when exposed to the same force compared to a material with a higher modulus of elasticity. The second and/or fourth polymer may have a lower hardness, in particular shore A and/or shore D hardness, compared to the first and/or third polymer, which may allow for a higher degree of deformation of the second and/or fourth compared to the first and/or third polymer when exposed to the same force.

In embodiments, the hinge 24 may be connected to the receiving head 28 at a connection shoulder, in particular wherein the connection shoulder comprises the second and/or fourth polymer. The hinge 24 may perform a hinge-type movement relative to the receiving head 28 in particular a hinge-type movement wherein the connection shoulder acts as the axis of rotation 42. Additionally to the aforementioned definitions, the term “hinge-type movement” may refer to the hinge 24 performing a rotational movement relative to the razor connector and/or receiving head 28 around the connection shoulder. The hinge may be connected to the receiving head 28 at two connection shoulders, wherein one connection shoulder is positioned on the top side 32 and/or top side 34 of the receiving head 28 and wherein one connection shoulder is positioned at the bottom side 36 and/or bottom side 38 of the receiving head 28. In embodiments, the connection shoulder may comprise the second and/or fourth polymer. In embodiments, the connection shoulder may comprise the second and/or fourth polymer and the hinge 24 and/or the receiving head comprise the first and/or third polymer. Manufacturing the connection shoulder with a material exhibiting lower modulus of elasticity may reduce the required force to actuate the hinge 24 and thereby the push-button 16. Alternatively or additionally, the connection shoulder may comprise a joining-structure, for example a pin-shaped structure, connecting the hinge 24 to the receiving head 28, in particular wherein the pin-shaped structure is tapered. The tapering may allow for improved rotation about the axis of rotation 42.

In embodiments, the flexible tongue 14 may comprise the second and/or fourth polymer. The flexible tongue 14 comprising the second and/or fourth polymer, more specifically a second and/or fourth polymer exhibiting a lower modulus of elasticity compared to the first and/or third, may in use allow the razor cartridge 100 to align to the skin of the user under less force. However, a flexible tongue 14 comprising the first and/or third polymer with a higher modulus of elasticity may provide a higher stability to the razor cartridge 100. In embodiments, the flexible tongue 14 may comprise the first and/or third polymer and the second and/or fourth polymer. This may allow adjusting the flexible tongue's 14 modulus of elasticity to an optimized value. In embodiments, the elastic structure 22 may comprise the second and/or fourth polymer. The elastic structure 22 comprising the second and/or fourth polymer may reduce the force required to actuate the push-button 16 and/or may allow the push-button 16 to move to a greater extent, before the elastic structure 22 breaks.

In embodiments, the hinge 24 and/or protrusion 20 may comprise the first and/or third polymer. The hinge 24 and/or protrusion 20 comprising the first and/or third polymer, more specifically a first and/or third polymer exhibiting a higher modulus of elasticity may lead to a higher rigidity of the parts which may improve the actuation mechanism, in particular the release of the razor cartridge 100 upon actuation. A higher rigidity of the hinge 24 may lead to a higher proportion of the force applied during actuation to be transferred to the protrusion 20, in particular as less force is absorbed by elastic deformation of the hinge 24. Similarly, a higher rigidity of the protrusion 20 may lead to a higher force transfer to the razor cartridge 100, as less force is absorbed by elastic deformation of the protrusion 20.

In embodiments, the push-element 24 may comprise the first and/or third polymer. The push-element 24 comprising the first and/or third polymer, more specifically a first and/or third polymer exhibiting a higher modulus of elasticity may lead to a higher rigidity of the push-element 24 which may improve the actuation mechanism, in particular the release of the razor cartridge 100 upon actuation. A higher rigidity of the push-element 24 may lead to a higher proportion of the force applied to the razor cartridge 100 during actuation, in particular as less force is absorbed by elastic deformation of the push-element 24.

In embodiments, the push-button 16 may comprise the first and/or third polymer.

In embodiments, the actuation surface may comprise the second and/or fourth polymer. The second and/or fourth polymer may have a higher tack and/or coefficient of friction compared to the second and/or fourth polymer and may therefore provide better grip to the user.

In embodiments, the tongue 14 may be connected to a spring, more specifically a spring configured to allow the tongue to move along the proximal-distal razor connector axis 40 and in particular a spring that compresses and stretches along the proximal-distal razor connector axis 40.

In a second aspect the present disclosure relates to a razor system comprising a razor connector 10 according to any preceding embodiment according to the first aspect and a razor cartridge 100, wherein the razor cartridge 100 is releasably attached to the razor connector 10.

In embodiments according to the second aspect the razor system may further comprise a razor handle 12 connected to the razor connector 10.

In a third aspect the present disclosure relates to a method for manufacturing a razor connector 10 any preceding embodiment according to the first aspect according to the first aspect. The method may comprise manufacturing the razor connector 10 using a computer-controlled manufacturing system, in particular additive manufacturing, material jetting, fused filament fabrication, stereolithography and/or selective laser sintering.

In a fourth aspect the present disclosure relates to a computer-based manufacturing system for manufacturing a razor connector 10, comprising a control unit adapted to execute the method according to the third aspect.

In a fifth aspect the present disclosure relates to a computer program comprising computer readable code which cause a computer-based manufacturing system to carry out the method according to the third aspect.

In a sixth aspect the present disclosure relates to a computer readable medium comprising the computer readable code according to the fifth aspect.

In an eighth aspect the present disclosure relates to a model of the razor connector 10 according to any embodiment according to the first aspect for a computer-controlled manufacturing system, wherein the model is configured to be processed by the computer-controlled manufacturing system to manufacture the razor connector.

In a ninth aspect, the present disclosure relates to a computer-readable medium, wherein the computer-readable medium comprises instructions configured to be processed by a computer-controlled manufacturing system to manufacture the razor connector 10 according to any embodiment according to the first aspect.

### ASPECTS

1. A razor connector (10) configured to connect a razor cartridge (100) to a razor handle (12) comprising:
   at least one interlocking feature configured to interlock with at least one interlocking part of the razor cartridge (100),
   a push-button (16) integrally formed with a hinge (24), wherein the push-button (16) is configured to rotate the hinge (24) from a first to a second position upon actuation,
   wherein rotation of the hinge (24) from the first to the second position is configured to disconnect the razor cartridge (100) from the razor connector (10).
2. The razor connector (10) according to aspect 1, wherein the razor connector (10) comprises a tongue (14), configured to allow pivotable movement of the razor cartridge (100) relative to the razor handle (12).
3. The razor connector (10) according to aspect 2, wherein the tongue (14) is a flexible tongue (14).
4. The razor connector (10) according to any preceding aspect, wherein the hinge (24) is configured to be in contact with the razor cartridge (100), when the razor cartridge (100) is connected to the razor connector (10).
5. The razor connector (10) according to any one aspects 2 to 4, wherein the tongue (14) extends from a distal end of the razor connector (10) and wherein the razor connector (10) is configured to be connected to the razor handle (12) at a proximal end and wherein the distal end and proximal end define a proximal-distal razor connector axis (40).
6. The razor connector (10) according to any preceding aspect, wherein the hinge (24) is arranged in distal direction of the push-button (16).
7. The razor connector (10) according to any preceding aspect, wherein the push-button (16) is connected to the hinge (24) by a strut (30).
8. The razor connector (10) according to any preceding aspect, wherein the hinge (24) is configured to rotate from the first position to the second position about an axis of rotation (42).
9. The razor connector (10) according to any one of aspects 5 to 8, wherein the hinge's axis of rotation (42) is substantially perpendicular to the proximal-distal razor connector axis (40).
10. The razor connector (10) according to any one of aspects 5 to 9, wherein the hinge's axis of rotation (42) is disposed further away from the proximal-distal razor connector axis (40) compared to the push-button (16) and/or the strut (30).
11. The razor connector (10) according to any preceding aspect, wherein the at least one interlocking feature is a recess (18), in particular a recess (18) configured to interlock with at least one interlocking protrusion of the razor cartridge (100).
12. The razor connector (10) according to any preceding aspect, wherein the at least one interlocking feature is an interlocking protrusion, in particular an interlocking protrusion configured to interlock with at least one recess of the razor cartridge (100)
13. The razor connector (10) according to any preceding aspect, wherein the hinge (24) is configured to disconnect the razor cartridge (100) from the razor connector (10) upon actuation of the push-button (16) by pushing the at least one interlocking part of the razor cartridge (100) out of the at least one interlocking feature.
14. The razor connector (10) according to any one of aspects 8 to 13, wherein the hinge (24) is configured to disconnect the razor cartridge (100) from the razor connector (10) upon actuation of the push-button (16) by pushing the at least one interlocking part of the razor cartridge (100) out of the at least one interlocking feature by at least a part of the hinge (24) moving in the distal direction due to the rotation of the hinge (24) around its axis of rotation (42).
15. The razor connector (10) according to any preceding aspect, wherein the hinge (24) is configured to push the at least one interlocking part out of the at least one interlocking feature by moving the at least one interlocking part of the razor cartridge (100) in distal direction relative to the at least one interlocking feature; or,
   wherein the hinge (24) is configured to push the at least one interlocking part out of the at least one interlocking feature by moving the at least one interlocking part of the razor cartridge (100) in the distal direction and away from the proximal-distal razor connector axis (40) relative to the at least one interlocking feature.
16. The razor connector (10) according to any preceding aspect, wherein the hinge (24) comprises a protrusion (20), in particular wherein the protrusion (20) is arranged on a distal end of the hinge (24), in particular wherein the protrusion (20) is configured to be in contact with the razor cartridge (100), when the razor cartridge (100) is connected to the razor connector (10).
17. The razor connector (10) according to any preceding aspect, wherein the push-button (16) moves from a proximal position to a distal position upon actuation.
18. The razor connector (10) according to any preceding aspect, wherein the push-button (16) is connected to an elastic structure configured to exert a biasing force on the push-button (16) to return the push-button from the distal position to the proximal position, in particular wherein the push-button and the elastic structure (22) are integrally formed.
19. The razor connector (10) according to aspect 18, wherein a cross-section of the elastic structure (22), in particular along the proximal-distal razor connector axis (40), is V-shaped, or curved, in particular at least partially a semi-circle.
20. The razor connector (10) according to aspect 18 or 19, wherein the elastic structure (22) comprises one or more circular arcs, in particular wherein a top-view of the elastic structure (22) is shaped as one or more circular arcs.
21. The razor connector (10) according to any one of aspects 16 to 20, wherein the protrusion (20) is configured to disconnect the razor cartridge (100) from the razor connector (10) upon actuation of the push-button (16) by pushing the at least one interlocking part of the razor cartridge (100) out of the at least one interlocking feature, more specifically wherein the protrusion (20) is configured to disconnect the razor cartridge (100) from the razor connector (10) upon actuation of the push-button (16) by pushing the razor cartridge's (100) protrusion of out of the razor connector's (10) recess (18) and in particular wherein the protrusion (20) is configured to disconnect the razor cartridge (100) from the razor connector (10) upon actuation of the push-button (16) by pushing the razor cartridge's (100) protrusion of out of the razor connector's (10) recess (18) by moving in the distal direction due to the rotation of the hinge (24) around its axis of rotation (42).
22. The razor connector (10) according to any preceding aspect, wherein the push-button (16) is preloaded when the razor cartridge (100) is connected to the razor cartridge (100); and/or, wherein the hinge (24) is preloaded when the razor cartridge (100) is connected to the razor cartridge (100).
23. The razor connector (10) according to any one of aspects 16 to 22, wherein the protrusion (20) is configured to preload the razor cartridge (100) when the razor cartridge (100) is connected to the razor connector (10).
24. The razor connector (10) according to any one of aspects 5 to 23, wherein the push-button (16) is moved towards the proximal direction of the proximal-distal razor connector axis (40) when preloaded.
25. The razor connector (10) according to any preceding aspect, wherein the razor connector (10) comprises a receiving head (28) configured to receive a connector sleeve (102) of the razor cartridge (100).
26. The razor connector (10) according to aspect 25, wherein the push-button (16) is arranged in proximal direction of the receiving head's (28) distal end.
27. The razor connector (10) according to any preceding aspect, wherein the push-button (16) comprises at least one actuation surface (26) configured to be actuated by a user to release the razor cartridge (100), in particular by moving the actuation surface (26) in distal direction of the proximal-distal razor connector axis (40).
28. The razor connector (10) according to aspect 27, wherein the at least one actuation surface (26) is disposed substantially perpendicular to the proximal-distal razor connector axis (40).
29. The razor connector (10) according to any one of aspects 18 to 28, wherein the elastic structure (22) is arranged between the actuation surface (26) and the hinge (24) and/or the protrusion (20).
30. The razor connector (10) according to any one of aspects 27 to 29, wherein the at least one actuation surface (26) comprises an indicator, more specifically a haptic indicator and in particular a protrusion (20), a dot, a cavity, a groove and/or a rubber element.
31. The razor connector (10) according to any preceding aspect, wherein the razor connector (10) has a top side (32) and a bottom side (36).
32. The razor connector (10) according to aspect 31, wherein the tongue (14) comprises a first section extending parallel to the proximal-distal razor connector axis (40) along the bottom side (36) of the razor connector (10) and a second section diverging towards the top side (32) of the razor connector (10).
33. The razor connector (10) according to aspect 31 or 32, wherein the push-button (16) is arranged on the top side (32) or bottom side (36) of the razor connector (10), in particular on the top side (32) of the razor connector (10).
34. The razor connector (10) according to any one of aspects 2 to 33, wherein the tongue (14) has a polygonal cross-section, more specifically a square, rectangular or octagonal shape and in particular a rectangular shape.
35. The razor connector (10) according to aspect 34, wherein a corner of the polygonal cross-section is round.
36. The razor connector (10) according to any preceding aspect, wherein the razor connector comprises a first (24a) and a second hinge (24b), wherein the first (24a) and the second hinge (24b) are disposed opposing one another, in particular wherein the proximal-distal razor connector axis (40) is disposed between the first (24a) and the second hinge (24b).
37. The razor connector (10) according to aspect 36, wherein the first hinge (24a) comprises a first protrusion (20a) and the second hinge (24b) comprises a second protrusion (20b).
38. The razor connector (10) according to aspect 36 or 37, wherein the first hinge (24a) is connected to the push-button (16) by a first strut (30a) and the second hinge (24b) is connected to the push-button (16) by a second strut (30b).
39. The razor connector (10) according to any one of aspect 36 to 38, wherein the first hinge (24a) is connected to a first push-button (16a), in particular by a first strut (30a), and the second hinge (24b) is connected to a second push-button (16b), in particular by a second strut (30b).
40. The razor connector (10) according to any one of aspects 25 to 39, wherein the at least one interlocking feature is positioned proximally of the receiving head's (28) distal end, more specifically on the bottom side (36) of the razor connector (10) on the receiving head (28) proximally of the receiving head's (28) distal end and in particular on the bottom side (36) of the razor connector (10) on the receiving head (28) proximally of the receiving head's (28) distal end adjacent to the tongue (14).
41. The razor connector (10) according to any preceding aspect, wherein the push-button (16) is integrally formed with the at least one interlocking feature.
42. The razor connector (10) according to any one of aspect 2 to 41, wherein the push-button (16) is integrally formed with the tongue (14).
43. The razor connector (10) according to any one of aspects 2 to 42, wherein the push-button (16), the at least one interlocking feature and the tongue (14) are integrally formed.
44. The razor connector (10) according to any preceding aspect, wherein the razor connector (10) is a one-piece part.
45. The razor connector (10) according to any preceding aspect, wherein the razor connector (10) comprises a plurality of layers, in particular a plurality of layers substantially parallel to each other.
46. The razor connector (10) according to any preceding aspect, wherein the razor connector (10) is integrally formed with the razor handle (12).
47. The razor connector (10) according to aspect 45 or 46, wherein a layer of the plurality of layers has a thickness between about 5 μm to about 100 μm, more specifically between about 10 μm to about 50 μm and in particular between about 15 μm to about 30 μm.
48. The razor connector (10) according to aspect 45 or 46, wherein a layer of the plurality of layers has a thickness between about 0.05 mm to about 0.6 mm, more specifically between about 0.1 μm to about 0.4 mm and in particular between about 0.15 mm to about 0.3 mm.
49. The razor connector (10) according to any preceding aspect, wherein the razor connector (10) comprises a first polymer, more specifically a photopolymer and in particular an ABS-like polymer and/or polypropylene-like polymer.
50. The razor connector (10) according to aspect 49, wherein the first polymer has a Shore D hardness between about 50 to about 120, more specifically between about 55 to about 100 and in particular between about 60 to about 90, measured according to ISO 868:2003.
51. The razor connector (10) according to any preceding aspect, wherein the razor connector (10) comprises a second polymer.
52. The razor connector (10) according to aspect 51, wherein the second polymer has a shore A hardness between about 10 to about 95, more specifically between about 25 to about 80 and in particular between about 35 to about 60, measured according to ASTM D2400-15.
53. The razor connector (10) according to any preceding aspect, wherein the razor connector (10) comprises a third polymer, more specifically a thermoplastic polymer and in particular ABS and/or polypropylene.
54. The razor connector (10) according to any preceding aspect, wherein the razor connector (10) comprises a fourth polymer, more specifically a thermoplastic elastomer and in particular a TPA, a TPC, a TPO, a TPS, a TPV, a TPZ and/or a TPU.
55. The razor connector (10) according to any one of aspects 25 to 54, wherein the hinge (24) is connected to the receiving head (28) at a connection shoulder (28), in particular wherein the connection shoulder (28) comprises the second and/or fourth polymer.
56. The razor connector (10) according to any one of aspects 2 to 55, wherein the flexible tongue (14) comprises the second and/or fourth polymer.
57. The razor connector (10) according to any one of aspects 51 to 56, wherein the elastic structure (22) comprises the second and/or fourth polymer.
58. The razor connector (10) according to any one of aspects 49 to 57, wherein the push-button (16) comprises the first and/or third polymer.
59. The razor connector (10) according to any one of aspects 49 to 57, wherein the protrusion (20) comprises the first and/or third polymer.
60. The razor connector (10) according to any one of aspects 2 to 59, wherein the tongue (14) is connected to a spring, more specifically a spring configured to allow the tongue (14) to move along the proximal-distal razor connector axis (40) and in particular a spring that compresses and stretches along the proximal-distal razor connector axis (40).
61. A razor system comprising a razor connector (10) according to any preceding aspect and a razor cartridge (100), wherein the razor cartridge (100) is releasably attached to the razor connector (10).
62. The razor system according to aspect 61, wherein the razor system further comprises a razor handle (12) connected to the razor connector (10).
63. A method for manufacturing a razor connector (10) according to any one of aspects 1 to 60 comprising:
   manufacturing the razor connector (10) using a computer-controlled manufacturing system, in particular additive manufacturing, material jetting, fused filament fabrication, stereolithography and/or selective laser sintering.
64. A computer-based manufacturing system for manufacturing a razor connector (10), comprising a control unit adapted to execute the method according to aspect 63.
65. A computer program comprising computer readable code which cause a computer-based manufacturing system to carry out the steps according to any one of aspects 63 or 64.
66. A computer readable medium comprising the computer readable code according to aspect 65.
67. A model of the razor connector (10) according to any one of aspects 1 to 60 for a computer-controlled manufacturing system, wherein the model is configured to be processed by the computer-controlled manufacturing system to manufacture the razor connector.
68. A computer-readable medium, wherein the computer-readable medium comprises instructions configured to be processed by a computer-controlled manufacturing system to manufacture the razor connector according to any one of aspects 1 to 60.

1. A razor connector configured to connect a razor cartridge to a razor handle comprising:
at least one interlocking feature configured to interlock with at least one interlocking part of the razor cartridge,
a push-button integrally formed with a hinge, wherein the push-button is configured to rotate the hinge from a first position to a second position upon actuation, wherein rotation of the hinge from the first position to the second position is configured to disconnect the razor cartridge from the razor connector.

2. The razor connector according to claim 1, wherein the razor connector comprises a tongue, configured to allow pivotable movement of the razor cartridge relative to the razor handle.

3. The razor connector according to claim 1, wherein the push-button is connected to the hinge by a strut.

4. The razor connector according to claim 1, wherein the hinge is configured to disconnect the razor cartridge from the razor connector upon actuation of the push-button by pushing the at least one interlocking part of the razor cartridge out of the at least one interlocking feature.

5. The razor connector according to claim 1, wherein the hinge is configured to push the at least one interlocking part out of the at least one interlocking feature by moving the at least one interlocking part of the razor cartridge in distal direction relative to the at least one interlocking feature; or,
wherein the hinge is configured to push the at least one interlocking part out of the at least one interlocking feature by moving the at least one interlocking part of the razor cartridge in the distal direction and away from the proximal-distal razor connector axis relative to the at least one interlocking feature.

6. The razor connector according to claim 1, wherein the push-button moves from a proximal position to a distal position upon actuation.

7. The razor connector according to claim 1, wherein the push-button is connected to an elastic structure configured to exert a biasing force on the push-button to return the push-button from the distal position to the proximal position, in particular wherein the push-button and the elastic structure are integrally formed.

8. The razor connector according to claim 1, wherein a protrusion is configured to preload the razor cartridge when the razor cartridge is connected to the razor connector.

9. The razor connector according to claim 1, wherein the hinge comprises a first hinge and a second hinge, wherein the first hinge and the second hinge are disposed opposing one another, in particular wherein the proximal-distal razor connector axis is disposed between the first hinge and the second hinge.

10. The razor connector according to claim 1, wherein the at least one interlocking feature is positioned proximally of a receiving head's distal end, more specifically on the bottom side of the razor connector on the receiving head proximally of the receiving head's distal end and in particular on the bottom side of the razor connector on the receiving head proximally of the receiving head's distal end adjacent to the tongue.

11. The razor connector according to claim 1, wherein the razor connector comprises a plurality of layers, in particular a plurality of layers substantially parallel to each other.

12. A razor system comprising a razor connector according to claim 1 and a razor cartridge, wherein the razor cartridge is releasably attached to the razor connector.

13. A method for manufacturing a razor connector according to claim 1 comprising:
manufacturing the razor connector using a computer-controlled manufacturing system, in particular additive manufacturing, material jetting, fused filament fabrication, stereolithography and/or selective laser sintering.

14. A model of the razor connector according to claim 1 for a computer-controlled manufacturing system, wherein the model is configured to be processed by the computer-controlled manufacturing system to manufacture the razor connector.

15. A computer-readable medium, wherein the computer-readable medium comprises instructions configured to be processed by a computer-controlled manufacturing system to manufacture the razor connector according to claim 1.

16. A razor connector configured to connect a razor cartridge to a razor handle comprising:
at least one interlocking feature configured to interlock with at least one interlocking part of the razor cartridge,
a push-button integrally formed with a push-element, wherein the push-button is configured to move the push-element from a first position to a second position upon actuation, and
wherein movement of the push-element from the first position to the second position is configured to disconnect the razor cartridge from the razor connector.

17. The razor connector according to claim 16, wherein the push element comprises a first push element and a second push-element, wherein the first push element and the second push-element are disposed parallel to one another, in particular wherein the proximal-distal razor connector axis is disposed between the first push and the second push-element.

18. The razor connector according to claim 1, wherein the push-element is configured to preload the razor cartridge when the razor cartridge is connected to the razor connector.
